(19) United States
(12) Patent Application Publication
(10) Pub. No.: US 2007/0271136 A1
(43) Pub. Date: Nov. 22, 2007

(54) Method for pricing advertising on the internet

(75) Inventors: Paul Strauss, Chicago, IL (US); Michael Morganstern, Chicago, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: DW Data Inc., Chicago, IL (US)

(21) Appl. No.: 11/438,050

(22) Filed: May 19, 2006

(51) Int. Cl. G06Q 30/00

(52) U.S. Cl. 705/14

(57) ABSTRACT

A method for determining a price charged to an advertiser to place a geographically targeted advertisement on an Internet web page or other remote area computer network is disclosed. The method involves the use of multiple databases containing pricing information; audience information, and advertisement information. An advertiser pricing information from a first database, identifies a target audience using information in a second database, defines the characteristics of the advertisement using information in a third database, and calculates a price for the advertisement based on the target audience and the characteristics of the advertisement. A method for allocating the time and day an advertisement appears based on an auction system is also disclosed.

### FIELD OF THE INVENTION

This invention pertains to online advertising and, in particular, to the concept of displaying relevant advertising based on geographic proximity of the viewer to the advertiser combined with scheduling preferences of the advertiser.

### BACKGROUND OF THE INVENTION

As personal computers have become commonplace in homes and offices, the Internet and World Wide Web have become the main source for news and information for many people. This is because the Internet and web offer the user the opportunity to access news and information when it is convenient for them as opposed to relying on a scheduled newscast on radio or television. Furthermore, the Internet and web provide the latest news and information on a story as opposed to the outdated information in a daily newspaper.

In addition to being a source of news and information, users are relying more and more on the Internet as a reference source to obtain information about products and services that more traditionally would have been discovered using telephone directories, trade journals, and product catalogs. Finally, the Internet is starting to replace libraries as a source of reference materials as, once again, the Internet provides the user with the flexibility to conduct research at the time and place the user desires.

The continuing development of technology will make the Internet and web more useful, thus occupying more of a user's time. It is for this reason that advertisers are turning to the Internet as a way of reaching consumers by advertising products and services that were previously only seen or heard about on the radio, television, newspapers, or magazines.

Internet advertising is well known and includes banner ads, pop-ups, and frame advertisements. As these forms of advertising—known as impressions—have become routine, consumers have learned to close the advertisement or ignore it completely. This is because most of the advertisement a consumer views over the Internet is directed to a general audience and most likely does not relate to a product or service in which the Internet user is interested.

As Internet use grows, it has become desirable to target advertising over the Web to individual consumers. Target advertising is not new as, for example, certain advertising sent by conventional mail is targeted to consumers based on their zip code. Also, as is disclosed in U.S. Patent Application Publication No. 2005/0144073 A1 (Morrisroe et al.) it is known to personalize advertising content over the Internet. One way of doing this, as disclosed by Morrisroe et al., is to combine personalized advertisement content with generic advertisement content.

A disclosed in Morrisroe et al., personalized advertising content can be generated over the Internet using, for example, a user's ZIP Code so as to allow the advertisement for movie theaters near the user's residence. Personalized advertising may also be directed to a chain of restaurants in a local area. This type of advertising might include a coupon to a local restaurant as well as advertisements for programming on local television stations.

For Internet advertising to be effective, however, in addition to targeting particular consumers it must be profitable to both the advertisers and the publishers of web pages on which advertisement appear. This problem has been addressed, for example, in U.S. Patent Application Publication No. 2004/0225562 A1 (Turner) which discloses a method for determining the placement of different Internet advertisements on different Internet publisher's web sites. This method helps a web page publisher to monitor the “performance” of a particular advertisement on a web page in order to determine pricing so as to allocate advertising space to the most productive advertisers.

U.S. Patent Application Publication No. 2002/0042738 A1 (Srinivasan et al.) also discloses a method and system that enables Internet businesses to conduct a real-time analysis of a transaction in order to determine marketplace sensitivities so as to optimize, among other things, the price charged for a product and the content of a banner ad appearing on a web site. Under this method, different forms of the same advertisement are presented to selected random samples of the population. The relative draw generated by each ad is then measured to determine which ads to show at a particular time.

Because the Internet is available 24 hours a day, 7 days a week it would be advantageous to have a method of allocating prime viewing time slots to advertisers so as to allow an advertiser to pay to have an ad shown in a particular time slot as opposed to relying on the web page publisher to schedule a particular run of ads over various time slots. Such a method would allow an advertiser to pay a premium to obtain a preferred viewing time.

### BRIEF SUMMARY OF THE INVENTION

The invention involves a method for determining a price charged to an advertiser to place an advertisement on an Internet web page or other remote area computer network. The method is comprised of: (a) providing a first database containing pricing information; (b) providing a second database containing audience information; (c) providing a third database containing advertisement information; (d) requesting pricing information from the first database; (e) identifying a target audience using information in the second database; (f) defining advertisement characteristics using information in the third database; and (g) calculating a price for the advertisement based on the target audience and the characteristics of the advertisement.

The invention also involves a method for allocating advertising space on a web page to a plurality of advertisers. The method is comprised of: (a) defining a geographic area in which the advertisement will appear; (b) selecting at least one day of a week in which the advertisement will appear; (c) choosing a block of time during the at least one day in which an advertisement will appear; (d) identifying a maximum price per “click” that each one of the plurality of advertiser will pay; and (e) setting a maximum price value of an advertising campaign in which the advertisement will appear. Using this form of an auction to allocate time on a web page to advertisers allows a large number of advertisers to bid for the day(s) of the week and the time(s) of day that a particular advertisement is displayed.

### BRIEF DESCRIPTION OF THE DRAWINGS

FIG. 1 is a schematic view of an Internet connection showing multiple computers connected together through a public network.

FIG. 2 is a flow chart showing a method for determining the price of an Internet advertisement that is targeted for viewing in a particular geographic region at a particular day and time.

FIG. 3 is a flow chart showing a method for determining the frequency at which a geographically targeted Internet advertisement is shown based on the price bid to show the ad at a particular time or day.

### DETAILED DESCRIPTION OF THE INVENTION

Internet advertising is well-known and the technical details associated with generating an advertisement or impression on a web page are well known to those skilled in the art. On a high level, a user uses an Internet browser to gain accesses to the Internet through a computer or any other electronic device that has the capability to connect to the Internet. The Internet browser can be Microsoft Explorer, Netscape Communicator, or any other browser known to those of skill in the art. These browsers allow a user to access a published web page and have the page displayed on the user's computer screen.

The invention involves a method for determining a price charged to an advertiser to place an advertisement on an Internet web page or other remote area computer network. The method is comprised of: (a) providing a first database containing pricing information; (b) providing a second database containing audience information; (c) providing a third database containing advertisement information; (d) requesting pricing information from the first database; (e) identifying a target audience using information in the second database; (f) defining advertisement characteristics using information in the third database; and (g) calculating a price for the advertisement based on the target audience and the characteristics of the advertisement.

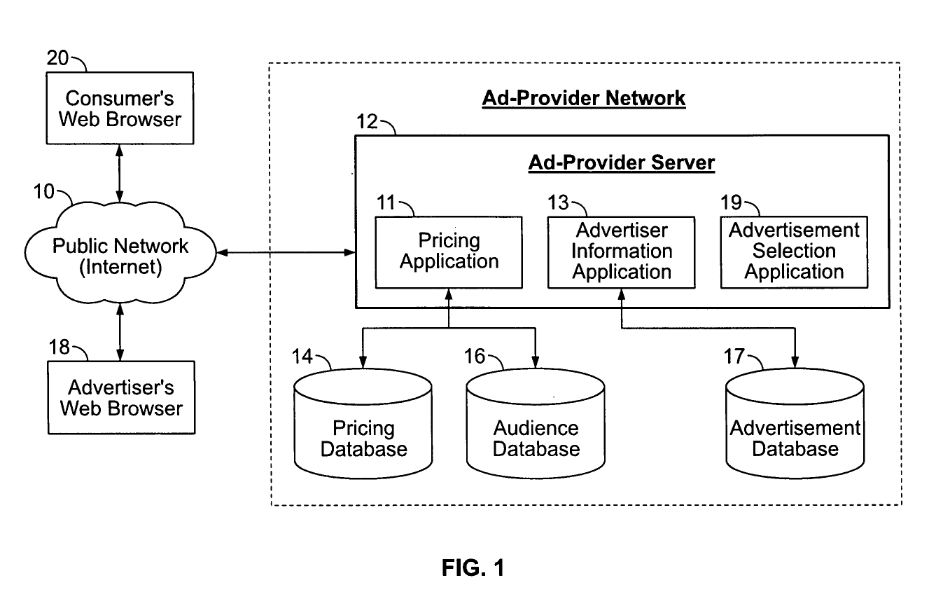

Referring to FIG. 1, an example of a system on which the method may be carried out will now be described. The system includes a public network 10 (e.g., the Internet) and an ad-provider server 12 linked to the public network 10. Existing on the ad-provider server 12 is a price calculation program 11 that has access to the first database 14 and the second database 16. The first database 14 contains information regarding pricing, while the second database 16 contains information regarding audience size. Also existing on the ad-provider server 12 is an application which captures advertiser information 13. The advertiser information application 13 stores advertiser contact, billing and advertisement details in the third database 17. In addition, an ad selection application 19 residing on the ad-provider server 12 determines relevant advertising to display to consumers 20 leveraging the data stored in the third database 17.

Also linked to the public network 10 are other computers, including an advertiser's computer 18 and a consumer's computer 20. The advertiser's computer 18 and the consumer's computer 20 will be referred to herein when describing examples of how the inventive method is carried out.

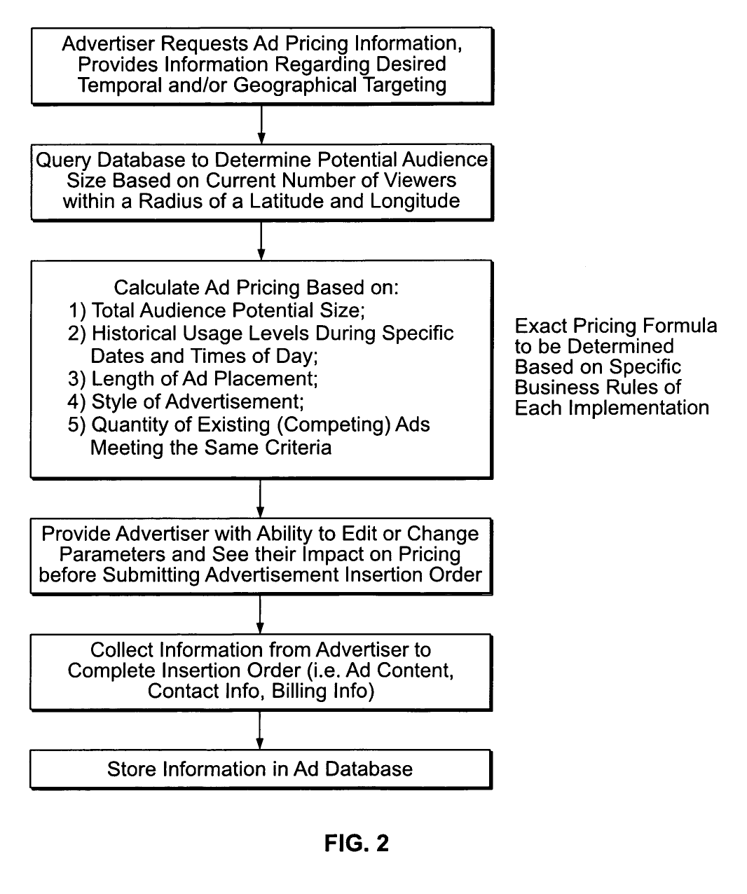

As shown in FIG. 2, when using this method, an advertiser, using his computer 18, requests pricing information for an advertisement from the first database 14. In making such a request, the advertiser provides information regarding its desired temporal (i.e., day of week, time of day, specific day) and/or geographical (i.e., zip code, latitude/longitude, address) target. Information in the first database 14 includes pricing information based on the time of day the advertisement appears on a web page. This information will allow an advertiser to determine whether to enable or disable its advertisement based on the time of day, day of the week, month of the year, or a specific date. For example, an advertiser of established goods or services may not desire to run an ad during the early morning hours of a typical week day while another advertiser, having a smaller advertising budget, may desire more frequent impressions at off-peak hours as a way of attempting to generate name recognition.

The first database 14 also includes pricing information based on a geographical area targeted by the advertisement. This information includes, among other things, the number of visitors to a publisher's web page or web site within a specific geographical area. Obviously it costs more to advertise in an area of greater population density as opposed to a more sparsely populated area. Because the Internet has a global reach, the ability to target advertising based on a user's location allows a web page publisher to vary the costs associated with an advertisement in response to the population density of a given area. In one embodiment of the invention, the center point of a given geographical area is identified using a coordinate defined by a particular latitude and longitude while the size of the area is defined by a radius extending from the particular coordinate. As with population density, the pricing information will vary based on the size of the geographical area an advertisement reaches.

After obtaining pricing information, the advertiser queries the second database 16 to determine, for example, the potential audience size based on the current number of viewers within a given radius of a particular latitude and longitude. The second database 16 also includes information about the number of visitors to a publisher's web page or web site based on time of day, day of week, and geographic locale of the visitors.

Having obtained general pricing information and information on the size of the viewing audience the advertisement will reach, a price for the ad is calculated. This calculation is based on factors such as the total size of the potential audience and the historical usage levels of the publisher's web page or web site during specific. Additional pricing variables are obtained by querying a third database which includes information on a period of time an advertisement would appear on the Internet. This database also includes information on the various styles of advertisements that are available to be purchased. Furthermore, the database may include information on advertisements of competing products or services. In one embodiment of the invention, the information on competing advertisements may include information as to the number of different advertisements for competing products or services that are appearing on the Internet. Given all of these factors a price for displaying an advertisement can be calculated on either a cost per impression or cost per click basis.

The information in each of the databases can be updated and changed at which time the price of a particular advertisement will be recalculated. Furthermore, an advertiser can edit or change various parameters and see the impact such changes have on the price of the advertisement before submitting an advertisement insertion order.

The inventive method also provides for the collection of information from the advertiser. This information includes, for example, billing information and information on advertisement content. Such information is stored in the first database.

The invention also provides a method for allocating advertising space on a web page to a plurality of advertisers. The method is comprised of: (a) defining a geographic area in which the advertisement will appear; (b) selecting a day of a week in which the advertisement will appear; (c) choosing a block of time during a day in which an advertisement will appear; (d) identifying a maximum price per “click” or per impression that each one of the plurality of advertiser will pay; and (e) setting a maximum price value of an advertising campaign in which the advertisement will appear. Using this form of an auction to allocate time on a web page to advertisers allows a large number of advertisers to bid for the day(s) of the week and the time(s) of day that a particular advertisement is displayed.

For example, assume that the target market for a group of advertisers is consumers who use the Internet during daily business hours (i.e., 9:00 A.M.-5:00 P.M.) Depending on the goods or services an advertiser was trying to sell, they may be willing to pay more to have an impression shown during one time of day, (e.g., 10:00 A.M.) as opposed to another time (e.g., 12:00 A.M.). In order for a publisher to obtain the maximum price for an impression, advertisers would bid for the day of the week and time of day they most desire their advertisement to appear. In this example, a local restaurant that was looking to attract a lunch time crowd would be willing to pay a premium to target its advertisement to having it appear a web page to users within a particular geographical area between 11:30 A.M. and 12:30 P.M. so as to entice people to eat at the restaurant during their lunch hour. Because the Internet has a global reach, Greenwich Mean Time is used as the reference point to determine when ads will appear to different locations around the world. The geographical viewing area is defined by determining a radial distance extending from a geographical center point of the area to a point on an outer boundary of the area;

This method of allocating advertising space benefits both the web page publisher and the advertiser. Using this method, the web page publisher is not required to negotiate an advertising price based on a cost per impression basis, typically a flat fee for given number of impressions, and then attempt to adequately allocate the impressions at various times of the day and week so as to generate business for the advertiser. Instead, a web page publisher is able to obtain the maximum value for the allocation of advertising space at a particular time based on a price set by the marketplace.

Advertisers benefit too in that they no longer have to worry about having their ad displayed during premium time periods for their business. Depending on the amount of money available for an advertising campaign, and the importance of having an advertisement displayed at a particular time, the advertiser can bid to pay a premium to have a given number of impressions appear during a particular time slot. In this method too, an advertiser having a limited advertising budget yet desiring to generate name recognition can maximize its exposure by purchasing multiple impressions during off-peak or low demand time slots. For example, an advertiser desiring to have his ad shown during the 11:00 A.M. hour may bid to pay 0.05 cents for each “click” on his ad from the publisher's web page. If, however, a second advertiser offers to pay 0.10 cents per “click” for the same time period, the ad for the second advertiser would be prioritized to be displayed in advance of the advertiser offering 0.05 cents per click. In this manner, an advertiser could divide the number of clicks or impressions into his total advertising budget to determine the maximum price per click or impression he was willing to bid. If on the other hand, the goal of the advertiser was to have as many impressions as possible at any time of the day, a minimum price per click could be determined.

The inventive method also solves the problems created with performance-based pricing in that a web page publisher does not have to determine whether a consumer made a purchase from an advertiser's web site as a result of being drawn to the site through an ad appearing on the web page publisher's site or by revisiting the advertiser's site at another time. By establishing the value of the time and day an impression is shown through an auction, the advertiser has already factored in the performance of the advertisement in the price he is willing to bid.

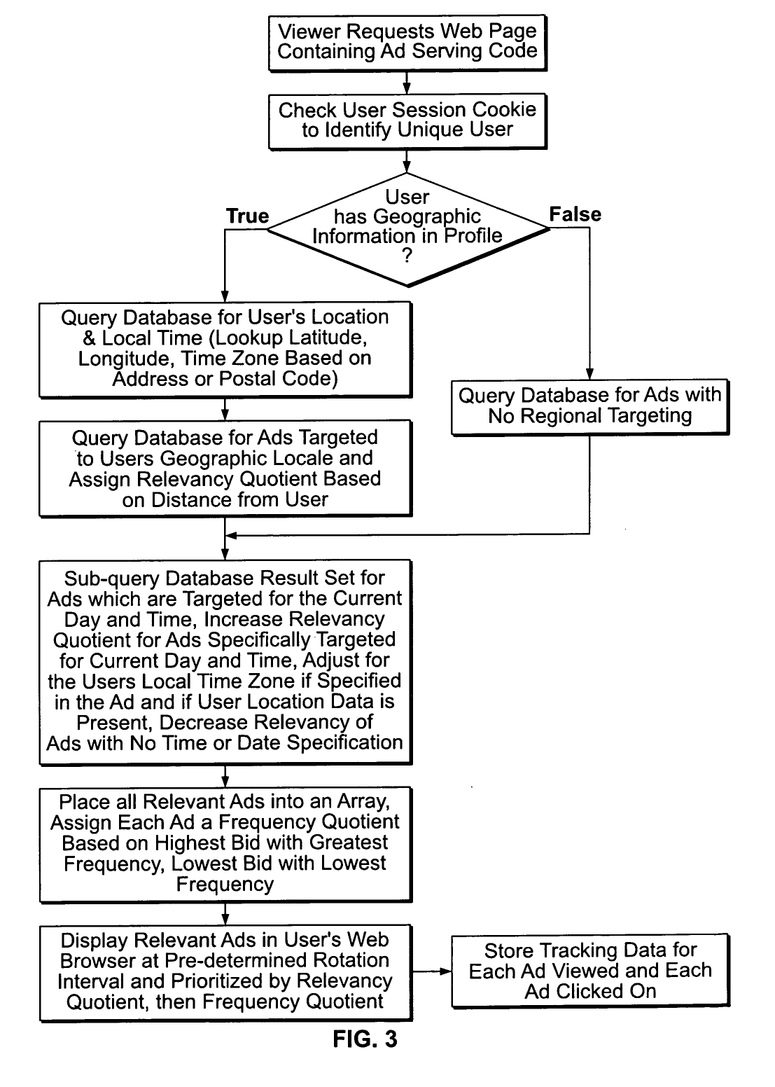

As shown in FIG. 3, when using the inventive method, a viewer requests a particular web page. A check of the user's session cookie is made to identify a unique user. A check is then made to determine if the user's geographic information is in the database. If no information is available, then the advertising database is queried for ads that are not targeted to any specific region. If geographic information is in the profile, a database query is made to determine the user's location and local time. A latitude, longitude, and time zone are also identified based on the user's address or postal code. An advertiser's database is then queried for ads targeted to a user's geographic locale. These ads are assigned a relevancy quotient based on distance from the user.

Once the relevancy quotient has been assigned, the advertising database is again queried for the subset of ads which are targeted for the current day and time. Ads that are specifically targeted for the current day and time have their relevancy quotient increased while the quotient for those having no time and date specification is decreased. Once this is completed, all relevant ads are placed into an array and each ad is assigned a frequency quotient ranging from the highest bid with the greatest frequency to the lowest bid with the lowest frequency. The ads are then displayed in a user's web browser at a pre-determined rotation interval with the ads being prioritized by relevancy quotient and then frequency quotient.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for determining a price for an advertiser to place an advertisement on an Internet web page, the method comprised of:
providing a first database containing pricing information;
providing a second database containing audience information;
providing a third database containing advertisement information;
requesting pricing information from the first database;
identifying a target audience using information in the second database;
defining advertisement characteristics using information in the third database; and
calculating a price for the advertisement based on the target audience and the characteristics of the advertisement.

2. The method of claim 1, wherein the first database includes pricing information based on the time of day the advertisement appears on a web page.

3. The method of claim 1, wherein the first database includes pricing information based on a geographical area targeted by the advertisement.

4. The method of claim 3, wherein a center point of the geographical area is identified using a coordinate defined by a latitude and a longitude and a size of the area is defined by a radius extending from the coordinate.

5. The method of claim 4, wherein the pricing information is based on the size of the geographical area.

6. The method of claim 4, wherein the pricing information is based on a number of visitors to a publisher's web page.

7. The method of claim 1, wherein the second database includes information on a population of consumers located in a geographic area centered on a coordinate defined by a latitude and a longitude.

8. The method of claim 7, wherein the information on the population of consumers includes population density of the geographic area.

9. The method of claim 7, wherein the information on the population consumers includes data on the days and time of day the population visits a publishers web page or web site.

10. The method of claim 1, wherein the third database includes information on a period of time the advertisement would appear.

11. The method of claim 1, wherein the third database includes information on various styles of advertisement available.

12. The method of claim 1, wherein the third database includes information competing advertisements.

13. The method of claim 12, wherein the information on competing advertisements includes the number of competing advertisements.

14. The method of claim 1 further comprised of:
changing the information received from at least one of the three databases; and
recalculating the price for the advertisement.

15. The method of claim 1 further comprised of collecting billing information from the advertiser.

16. The method of claim 15, wherein the billing information includes advertisement content.

17. The method of claim 15 further comprised of storing the collected billing information in the first database.

18. A method for allocating advertising space on a web page to a plurality of advertisements, the method comprised of:
defining a geographical area in which one of the plurality of advertisement will appear;
selecting at least one day of a week in which one of the plurality of advertisement will appear;
choosing a block of time during the at least one day in which one of the plurality of advertisement will appear;
identifying a maximum price per “click” or impression that each one of the plurality of advertisements will pay; and
setting a maximum price value of an advertising campaign in which the advertisement will appear.

19. The method of claim 18, wherein the geographical area is defined by determining a radial distance extending from a geographical center point of the area to a point on an outer boundary of the area.

20. The method of claim 18 further comprising assigning a relevancy quotient to the advertisement, the relevancy quotient being based on a distance a user is from the defined geographical area.

21. The method of claim 20 further comprising increasing the relevancy quotient for advertisements specifically target for a particular day and time.

22. The method of claim 20 further comprising decreasing the relevancy quotient for advertisements not specifically target for a particular day and time.

23. The method of claim 20 further comprising assigning a frequency to each advertisement.

24. The method of claim 23, wherein the frequency quotient is the highest for an advertisement having the highest bid and lowest for an advertisement having the lowest bid.

25. The method of claim 23 further comprising displaying each of the plurality of advertisements in a web browser at pre-determined rotation intervals with each of the plurality of advertisements prioritized firs by a relevancy quotient and second by a frequency quotient.
